(19) United States
(12) Patent Application Publication
(10) Pub. No.: US 2012/0322551 A1
(43) Pub. Date: Dec. 20, 2012

(54) Motion Detection Method, Program and Gaming System

(75) Inventors: Jason Brennan, Toshima-ku (JP); Colin Barrett, Dunboyne (IE)

(73) Assignee: OMNIMOTION TECHNOLOGY LIMITED, Dublin (IE)

(21) Appl. No.: 13/498,569

(22) PCT Filed: Sep. 28, 2009
(86) PCT No.: PCT/EP2009/062504

§ 371 Date: Aug. 7, 2012

(51) Int. Cl. A63F 13/00

(52) U.S. Cl. 463/31

(57) ABSTRACT

This invention relates to a method of processing an image, specifically an image taken from a web camera. The processed image is thereafter preferably used as an input to a game. The image is simplified to a point whereby a very limited number of region bounded boxes are provided to a game environment and these region bounded boxes are used to determine the intended user input. By implementing this method, the amount of processing required is decreased and the speed at which the game may be rendered is increased thereby providing a richer game experience for the player. Furthermore, the method of processing the image is practically universally applicable and can be used with a wide range of web cameras thereby obviating the need for additional specialist equipment to be purchased and allowing the games to be web based.

### INTRODUCTION

This invention relates to a method of processing an image. More specifically, this invention relates to a method of processing an image taken by a video device, preferably a webcam. Preferably, after processing the image taken by the video device, the data obtained as a result of processing the image is used as a control input in a game environment.

Recently, there has been a shift in popularity away from games that use traditional input devices such as joysticks, keyboards and computer mice towards games that track more significant movements of the user and provide those movements as inputs to the game. These games are seen as an effective way of getting players to take exercise while enjoying their gaming experience. One example of a game system that tracks the user's movements and provides them as inputs to a game is the Wii® console produced by Nintendo®. The Wii console supports a range of user operated devices including the Wii remote that have means to track the orientation and speed of movement of the user operated device and use that data as an input to the game.

Another example of a game system that is able to track a user's movements and provides the movements as inputs to a game is the Playstation® Eye used with the Playstation 3 console produced by Sony®. The advantage of this system over the other known systems is that this system uses a video camera to detect user movement instead of a controller and therefore does not require the user to hold or wear any additional equipment. The present invention relates to this latter type of game system whereby the users movements may be tracked using a video device without the need for the player to hold or wear additional equipment.

There are however problems with the known types of games systems. First of all, the known types of game systems are relatively expensive and therefore are not accessible to all players. In addition to the consoles being relatively expensive, these systems require a specialised camera to be purchased that can interface with the games console which further adds to the cost of these games systems.

A second problem with the known systems is that the information taken from the video camera requires a significant amount of processing power and places a significant computational burden on the games console. This is undesirable as the consoles are already under a significant processing burden due to the amount of processing required to render the rich graphics that are expected by game players.

It is an object of the present invention to provide a method of processing an image that overcomes at least some of the problems with the known methods. It is a further object of the present invention to provide a games system that overcomes at least some of the problems with the known systems.

### STATEMENTS OF INVENTION

According to the invention there is provided a method of processing an image taken from a video device, the method comprising the steps of:
performing an inter-frame differencing technique on the image to create an inter-frame difference mask;
identifying connected regions of the inter-frame difference mask;
grouping each of the connected regions of the inter-frame difference mask in a bounded box; and
grouping the bounded boxes within a predetermined threshold distance of each other together in a region bounded box.

By processing the image in such a fashion, the amount of information returned to the programming environment is significantly reduced. When the method is implemented in a game development environment this makes the programming of the games faster and reduces the amount of processing required in the game development environment. Furthermore, the amount of information required for playing the game is also significantly reduced and this helps to provide a game that may be rendered very quickly providing a very enjoyable, realistic game experience. Furthermore, importantly, the technique can be employed with a broad, practically universal range of web cams and other video devices and therefore will not require additional equipment to be purchased.

In one embodiment of the invention there is provided a method comprising the intermediate step of:
applying a desired region mask to the inter-frame difference mask.

This is seen as particularly useful as this will enable more useful information to be gleaned from the image while at the same time keeping the amount of information provided to a minimum. Furthermore, the desired region mask can eliminate unnecessary processing of information thereby speeding up the processing of images and reducing the amount of processing required.

In another embodiment of the invention there is provided a method in which the desired region mask comprises at least one rectangular clear region.

In one embodiment of the invention there is provided a method in which the desired region mask comprises a divider clear region that extends across the inter-frame difference mask thereby dividing it into two distinct areas, one either side of the clear region.

In another embodiment of the invention there is provided a method in which the divider clear region extends from the top of the inter-frame difference mask to the bottom of the inter-frame difference mask.

In one embodiment of the invention there is provided a method in which the divider clear region is located substantially centrally in the inter-frame difference mask thereby dividing the inter-frame difference mask into two substantially equal halves.

In another embodiment of the invention there is provided a method comprising the additional steps of:
determining whether there are a plurality of region bounded boxes in a segment of the image; and
disregarding all but the most extreme region bounded box in that segment of the image from further processing.

This is seen as a useful way to eliminate the amount of processing that must be carried out.

In one embodiment of the invention there is provided a method in which the step of grouping the bounded boxes within a predetermined threshold distance of each other together in a region bounded box further comprises the steps of:
expanding each bounded box by half the threshold distance;
joining each bounded box with the union of all overlapping boxes.

In another embodiment of the invention there is provided a method comprising the additional steps of:
sorting the bounded boxes by a union ID; and
merging bounded boxes with the same union ID into a region bounded box.

In one embodiment of the invention there is provided a method comprising the step of:
generating a new region bounded box for each bounded box that cannot be merged with another bounded box or region bounded box.

In another embodiment of the invention there is provided a method in which the step of performing an inter-frame differencing technique on the image to create an inter-frame difference mask comprises creating a binary motion mask image.

In one embodiment of the invention there is provided a method in which the step of performing an inter-frame differencing technique on the image to create an inter-frame difference mask comprises the steps of:
transforming the image into an intensity image comprising a plurality of pixels, each pixel having a pixel value;
filtering the intensity image to smooth out the pixel values;
subtracting each pixel value of a previous intensity image from the corresponding pixel value of the current intensity image;
calculating the absolute value of the difference between the pixel values; and
thresholding the absolute value of the difference between the pixel values.

In another embodiment of the invention there is provided a method in which the desired region mask comprises passing a lattice of a plurality of rectangular clear regions, a plurality of the rectangular clear regions being arranged vertically and a plurality of the rectangular clear regions being arranged horizontally and the vertical and horizontal clear regions intersecting each other to form a lattice desired region mask. By applying such a mask, a grid is placed on the image and this grid may be used to create a plurality of mini areas of interest. From these, information such as the speed of motion and the accurate direction information may be taken.

In one embodiment of the invention there is provided a computer program having program instructions for causing a computer to implement the method.

In another embodiment of the invention there is provided a computer program stored on a computer readable medium.

In one embodiment of the invention there is provided a method of providing an input to a game executing on a computing device, the method comprising the steps of:
capturing an image of the movements of a player using a video device;
performing an inter-frame differencing technique on the image to create an inter-frame difference mask;
identifying connected regions of the inter-frame difference mask;
grouping each of the connected regions of the inter-frame difference mask in a bounded box;
grouping the bounded boxes within a predetermined threshold distance of each other together in a region bounded box; and
passing the region bounded box as the input to a game playback engine.

In another embodiment of the invention there is provided a method of providing an input to a game executing on a computing device in which the step of capturing the movements of a player using a video device comprise capturing the movements of the player using a web camera.

In one embodiment of the invention there is provided a method of providing an input to a game executing on a computing device comprising the intermediate step of:
applying a desired region mask to the inter-frame difference mask.

In another embodiment of the invention there is provided a method of providing an input to a game executing on a computing device in which the desired region mask comprises at least one rectangular clear region.

In one embodiment of the invention there is provided a method of providing an input to a game executing on a computing device in which the desired region mask comprises a divider clear region that extends across the inter-frame difference mask thereby dividing it into two distinct areas, one either side of the clear region.

In another embodiment of the invention there is provided a method of providing an input to a game executing on a computing device in which the divider clear region extends from the top of the inter-frame difference mask to the bottom of the inter-frame difference mask.

In one embodiment of the invention there is provided a method of providing an input to a game executing on a computing device in which the divider clear region is located substantially centrally in the inter-frame difference mask thereby dividing the inter-frame difference mask into two substantially equal halves.

In another embodiment of the invention there is provided a method of providing an input to a game executing on a computing device comprising the additional steps of:
determining whether there are a plurality of region bounded boxes in a segment of the image; and
disregarding all but the most extreme region bounded box in that segment of the image from further processing.

In one embodiment of the invention there is provided a gaming system comprising:
a computing device having a processor, an accessible memory and a visual display unit (VDU);
a game engine for receiving user inputs, executing game code on the computer and displaying game graphics responsive to the user inputs on the VDU;
a video device associated with and in communication with the computing device;
a receiver to receive an image from the video device;
an inter-frame difference mask generator to generate an inter-frame difference mask from the image;
means to identify connected regions of the inter-frame difference mask;
means to group each of the connected regions of the inter-frame difference mask in a bounded box;
means to group the bounded boxes within a predetermined threshold distance of each other together in a region bounded box; and
means to deliver the region bounded box as a user input to the game engine.

In another embodiment of the invention there is provided a gaming system in which the video device is a web cam.

In one embodiment of the invention there is provided a gaming system comprising masking means to apply a desired region mask to the inter-frame difference mask.

In another embodiment of the invention there is provided a gaming system in which the desired regions mask comprises at least one rectangular clear region.

In one embodiment of the invention there is provided a gaming system in which the desired region mask comprises a divider clear region that extends across the inter-frame difference mask thereby dividing it into two distinct areas, one either side of the clear region.

In another embodiment of the invention there is provided a gaming system in which the divider clear region extends from the top of the inter-frame difference mask to the bottom of the inter-frame difference mask.

In one embodiment of the invention there is provided a gaming system in which the divider clear region is located substantially centrally in the inter-frame difference mask thereby dividing the inter-frame difference mask into two substantially equal halves.

In another embodiment of the invention there is provided a gaming system comprising:
means to determine whether there are a plurality of region bounded boxes in a segment of the image; and
means to disregarding all but the most extreme region bounded box in that segment of the image from further processing.

In one embodiment of the invention there is provided a method of developing a game for a gaming system comprising the steps of:
capturing an image of the desired movements of a player using a video device;
performing an inter-frame differencing technique on the image to create an inter-frame difference mask;
identifying connected regions of the inter-frame difference mask;
grouping each of the connected regions of the inter-frame difference mask in a bounded box;
grouping the bounded boxes within a predetermined threshold distance of each other together in a region bounded box;
designating the region bounded box as a user input to a game; and
matching the user input with a game action.

### DETAILED DESCRIPTION OF THE INVENTION

The invention will now be more clearly understood from the following description of some embodiments thereof given by way of example only with reference to the accompanying drawings, in which:—

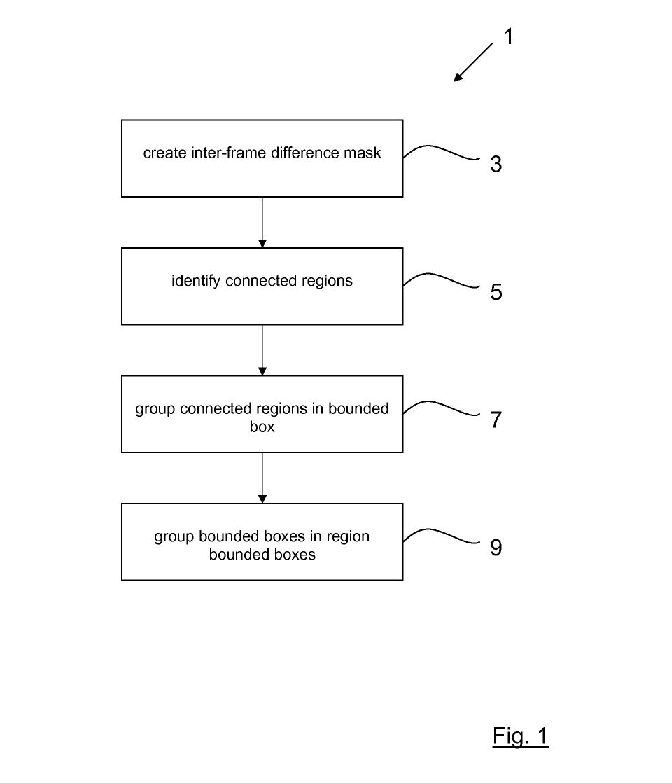

FIG. 1 is a flow diagram illustrating a method of processing an image according to the present invention;

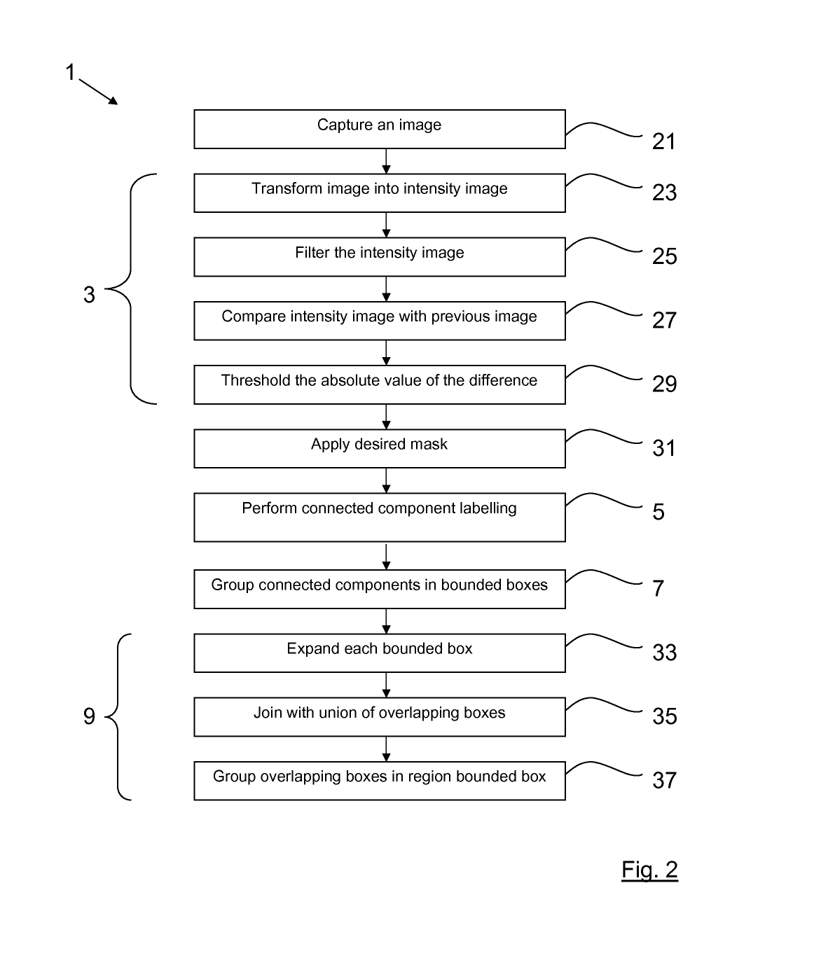

FIG. 2 is an expanded flow diagram illustrating some of the method steps of FIG. 1 in greater detail;

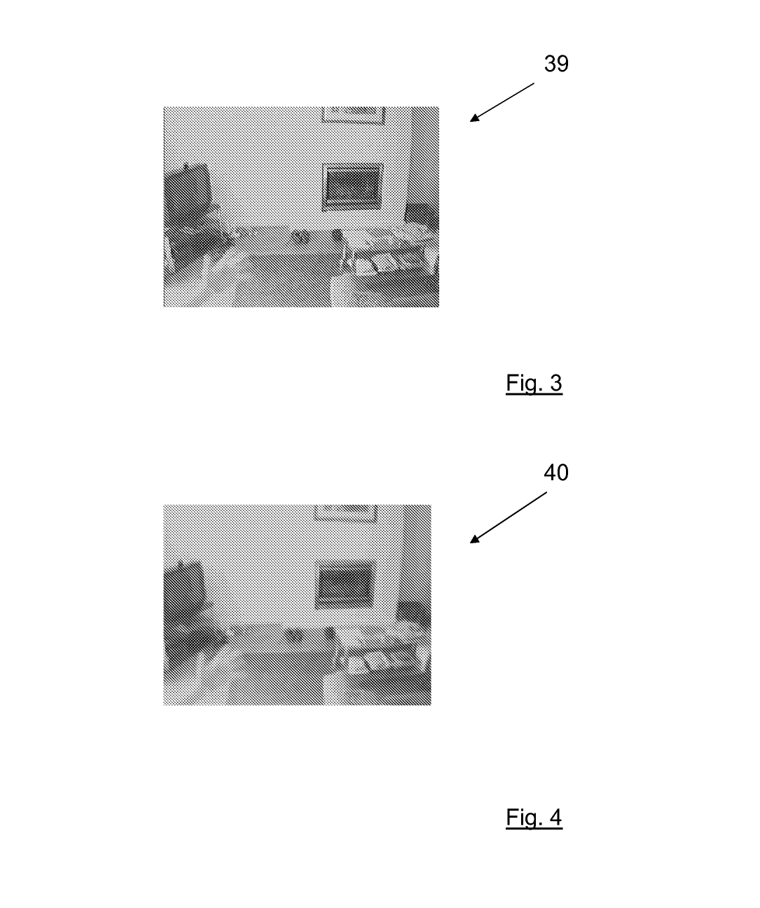

FIG. 3 is an intensity image used in the method according to the present invention;

FIG. 4 is the intensity image of FIG. 3 shown after filtering;

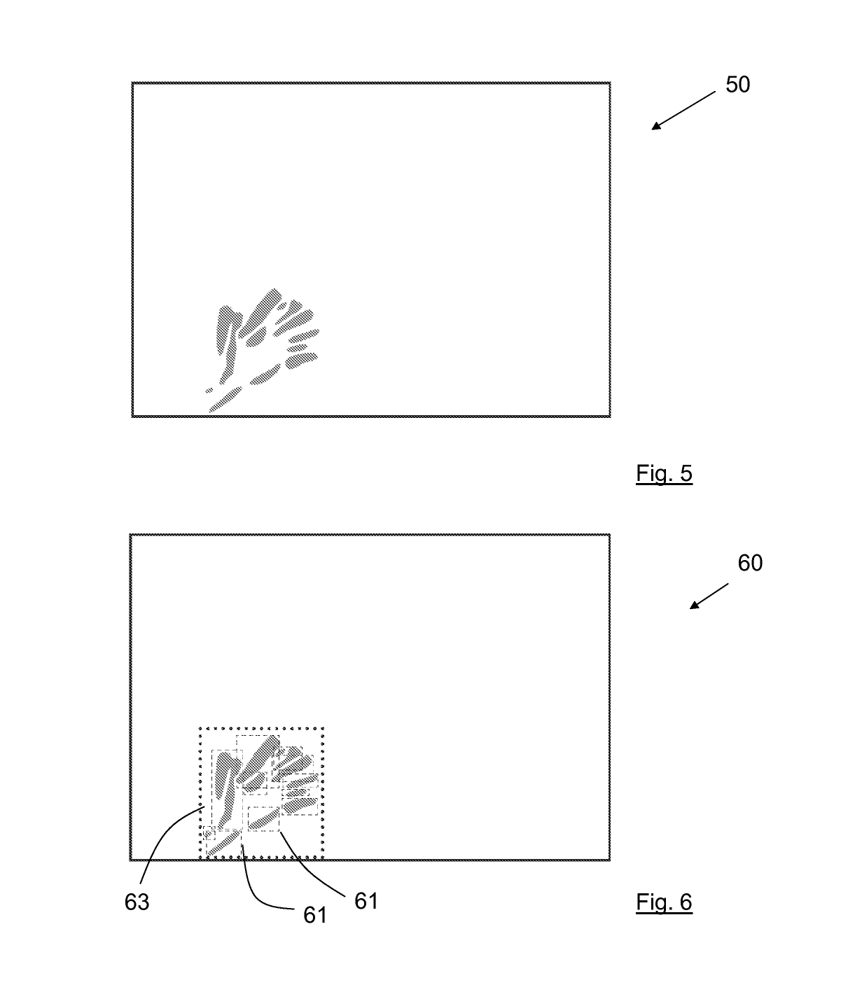

FIG. 5 is an inter-frame difference mask;

FIG. 6 is an inter-frame difference mask showing the bounding boxes and the region bounding box;

FIG. 7 is a diagrammatic representation of a first embodiment of a desired regions mask;

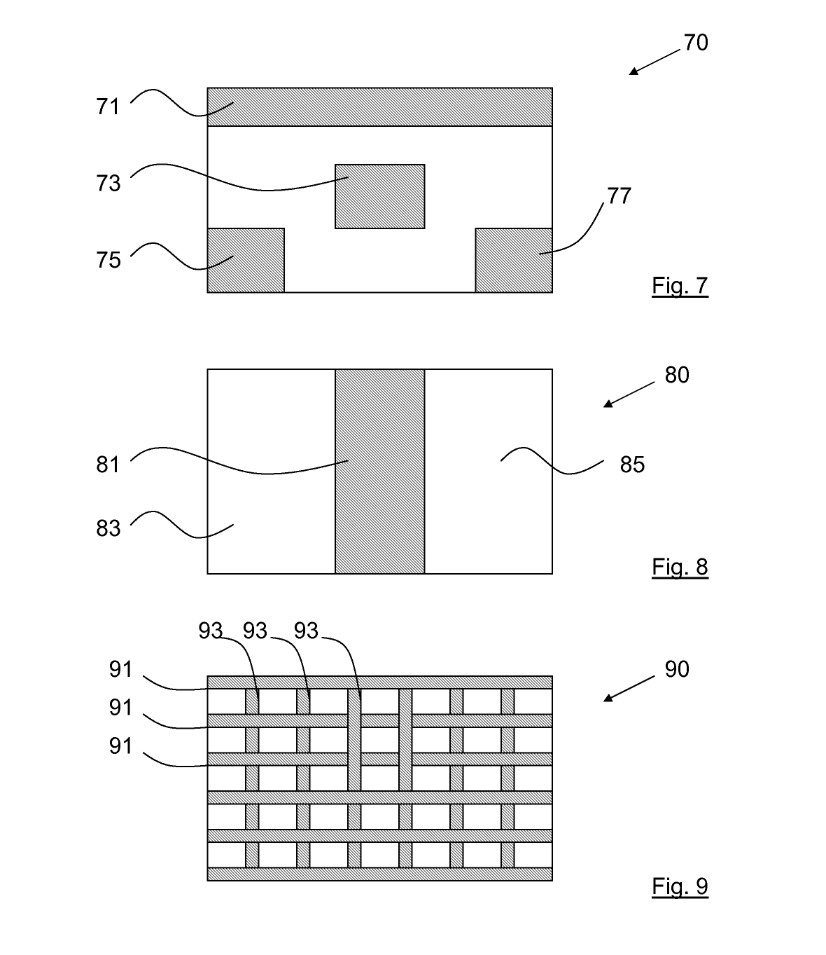

FIG. 8 is a diagrammatic representation of a second embodiment of a desired regions mask;

FIG. 9 is a diagrammatic representation of a third embodiment of a desired regions mask;

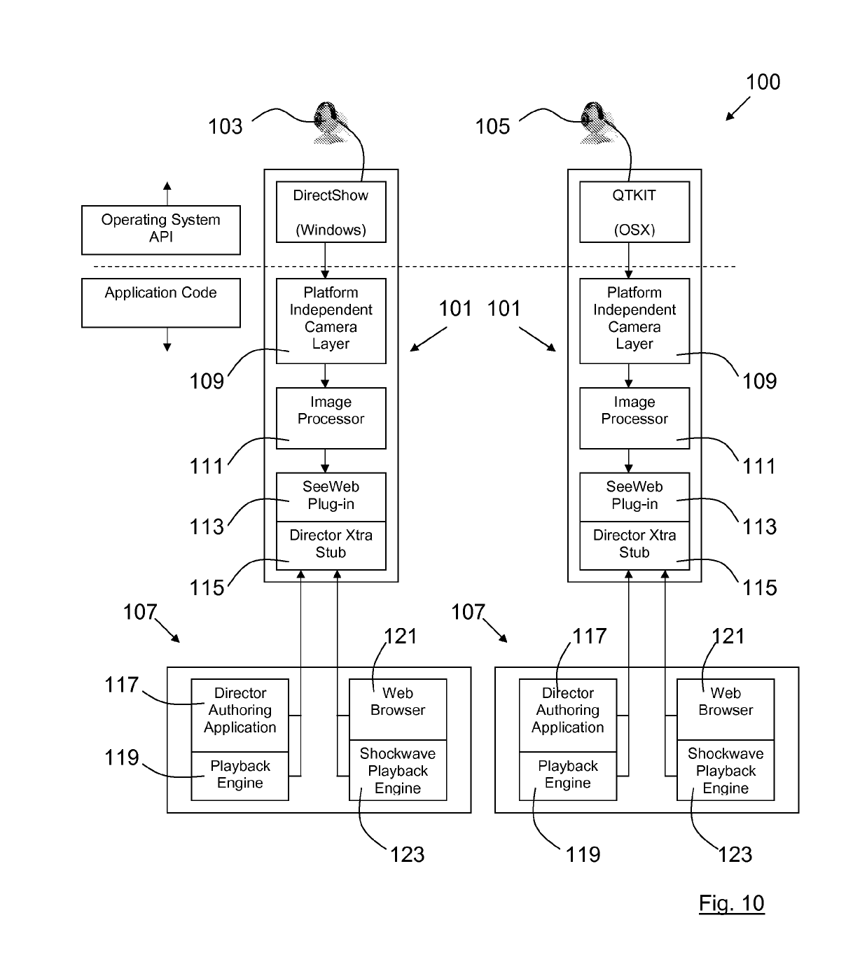

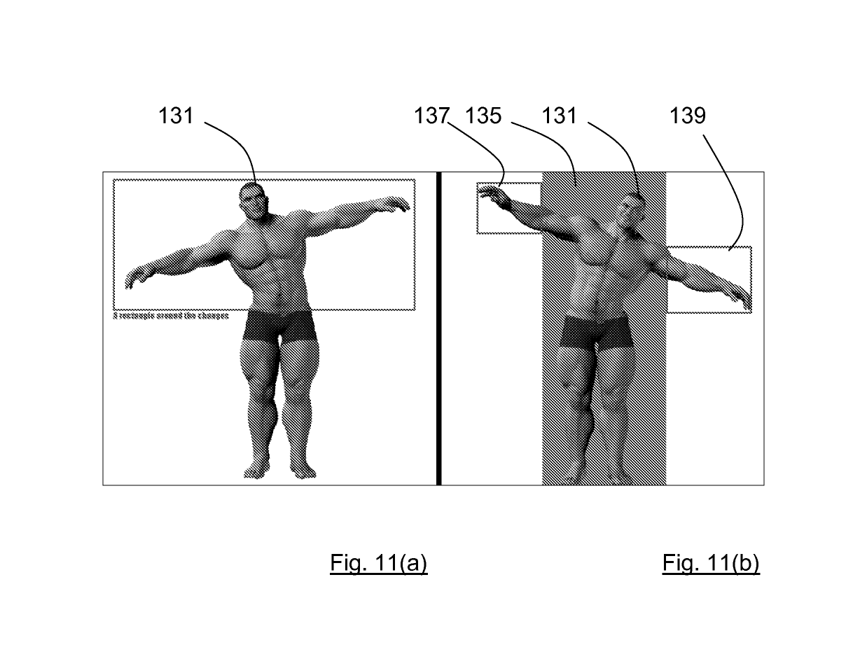

FIG. 10 is a diagrammatic representation of a system in which the method according to the present invention operates; and

FIGS. 11(a) and 11(b) are diagrammatic representations showing the region bounded boxes obtained from an image.

Referring to the drawings and initially to FIG. 1 thereof, there is shown a flow diagram of the method according to the present invention, indicated generally by the reference numeral 1. The method comprises the initial step 3 of performing an inter-frame differencing technique on a captured image (not shown) to create an inter-frame difference mask. Once the inter-frame difference mask has been created, the method proceeds to step 5 in which the connected regions of the inter-frame difference mask are identified and in step 7 the connected regions of the inter-frame difference mask are grouped in a bounded box. Once grouped in bounded boxes, the bounded boxes within a predetermined threshold distance of each other are in turn grouped into region bounded boxes in step 9. The grouped bounded boxes may then be used as inputs to a game or as an input in a computer application running on a computing device (not shown).

Referring to FIGS. 2 to 7, there is described a method of processing an image according to the invention in greater detail, where like parts have been given the same reference numerals as before. Referring initially to FIG. 2, there is shown an expanded flow diagram of the method according to the present invention. In step 21, an image is captured in the normal manner by a video device, in this case a web cam. The image is in a first, rich format, for example RGB888 format. In this format, there are three unsigned bytes per pixel, one unsigned byte for red, one unsigned byte for green and one unsigned byte for blue.

The image in RGB format is transformed into an intensity image in step 23, effectively a greyscale representation of the image. The intensity image is often referred to as the “Y” image. The Y image is then used for subsequent processing. An example of a Y image is shown in FIG. 3, indicated by the reference numeral 39. In order to transform the RGB888 image format into an intensity image, the intensity values of each of the pixels is calculated using the relation:

Y=((66*R+129*G+25*B+128)>>8)+16

Once transformed into an intensity image, the intensity image is smoothed in step 25 by passing the intensity image through a Gaussian filter. The Gaussian filter uses a 5*5 Kernel to distribute sample noise. This diminishes the appearance of spikes caused by the camera hardware where no actual motion has occurred. An example of a filtered image is shown in FIG. 4, indicated by the reference numeral 40.

In order to provide the inter-frame difference mask, the smoothed intensity image must be compared with the previous smoothed intensity image in step 27. By previous, what is meant is the last, most recent image captured by the camera that was taken just prior to the current image being processed. For each pixel, the pixel intensity value of the previous smoothed intensity image is subtracted from the pixel intensity value of the current intensity image. This will return an integer value for each pixel and the absolute value of that integer value is determined and then compared with a threshold value set by the user in step 29. The threshold value will determine the sensitivity of the method in creating the inter-frame difference mask. If the result exceeds the threshold value, the corresponding pixel in the inter-frame difference mask is marked as having changed from a previous value and the corresponding pixel in the inter-frame difference mask will be filled. If the result does not exceed the threshold value, the corresponding pixel in the inter-frame difference mask is marked as not having changed from a previous value and the corresponding pixel in the inter-frame difference mask will not be filled. These operations are carried out using the following operational logic:

Iad = abs (Ic − Ip_{—}
// kThreshold is threshold value, set by user
If ( Iad > kThreshold)

Im = 0xff

Else

Im = 0x00

Once all of the pixels have been compared and thresholded, the inter-frame difference mask is created. An example of an inter-frame difference mask is shown in FIG. 5, indicated by the reference numeral 50. In this case, a users hand, shown in the bottom left corner of the intensity image 39 in FIG. 3 and the filtered intensity image 40 in FIG. 4 moved between the previous image captured by the camera and the present image captured by the camera. As this was the only change in the image, these pixels will have changed and the altered pixels are represented as a hand-like image in the bottom left hand corner of the inter-frame difference mask 50.

Returning to FIG. 2, if desired, the inter-frame difference mask can have a desired region mask applied to it in step 31. A more detailed description of the desired regions mask is provided below. In step 5, the process entails connected component labeling. This involves identifying connected regions in the inter-frame difference mask and grouping them together in bounded boxes in step 7. These bounded boxes are shown in green (dashed) outline.

Effectively, the technique for grouping the connected components, otherwise referred to as “blobs”, comprises the following steps: First of all, a run-length encode of the binary input image (the inter-frame difference mask) is performed. Secondly, the run-length encode image is raster-scanned, comparing runs on each new line to runs on the line immediately preceding that line. Third, for 6-2 connectivity, 8 cases need to be considered for relevant combinations of “current-run” and “previous-run”. Depending on the combination, “current-run” either starts a new region or joins an old region. In certain cases, old regions are subsumed where two regions determined to be disjoint on a previous iteration are found to be connected on a new iteration. Fourth, statistical moments, bounding box information and measures of area are updated at each step. Fifth, small “blobs” below a certain specified area size are discarded before returning the results. The above technique for grouping the blobs is known in the art.

Once the connected components have been grouped in step 7, the output of that stage is a list of region descriptors. The only information used by the method and apparatus according to the present invention is the image-aligned bounding box information (the dashed lines 61 shown in FIG. 6). This information is then used in a union find operation to connect component regions within a certain distance threshold distance from each other together. The union find operation comprises a first step 33 of expanding each of the image-aligned bounded boxes by half the threshold distance, a second step 35 of for each box, joining the union of the overlapping boxes, sorting the boxes by a union ID and thereafter iterating the sorted boxes and grouping the boxes with the same root union ID in a region bounded box in step 37 and starting a new region for a new root union ID. Once the bounded boxes have been grouped, there is provided a region bounded box indicated by the red (dotted) line 63 in FIG. 6. The output of this stage is a list of one or more region bounded boxes, where each region bounded box bounds boxes from the previous stage that fell within the distance threshold of each other. The region bounded box is then used as a simple input for a game or other application running on a computer.

As mentioned above, a desired region mask could be applied to the inter-frame difference mask 39. An example of a desired region mask is shown in FIG. 7 and is indicated generally by the reference numeral 70. The desired region mask comprises a plurality of “cleared” regions 71, 73, 75, 77 that have been selected by the programmer that creates the game. By providing a desired region mask, any activity in those regions covered by the rectangular desired region mask may be ignored. This can significantly reduce the amount of processing required as only the areas of interest outside the desired region mask are processed. The number and size of the rectangles may be specified by the game programmer. The operation that is performed to delete any material in the desired region mask area is as follows:
If (Idr=0x00)
   Im=0x00

Referring to FIG. 8, there is shown an alternative embodiment of a desired region mask, indicated generally by the reference numeral 80. The desired region mask 80 comprises a divider clear region 81 which extends from the top of the image all the way to the bottom of the image and is substantially centrally located in the image. In this way, the image is divided into two distinct areas 83, 85, one of which is to the left of the divider clear region and the other of which is to the right of the divider region. In this way, it is possible to clearly identify activity that occurs in a particular region as being the result of activity in that region only. For example, if the game requires an activity to be carried out by the left arm of a player and an activity to be performed by the right arm of the player, the divider clear region 81 will prevent motion in one region 83 being misinterpreted as activity in the other region 85 and vice versa.

Referring to FIG. 9, there is shown a further alternative embodiment of a desired region mask, indicated generally by the reference numeral 90. The mask comprises a plurality of rectangular cleared regions, some of which 91 are arranged horizontally across the image and others of which 93 are arranged vertically across the image. This mask is seen as particularly useful as it can effectively cause the motions applied by a user and captured by the camera to be slowed so that the movement appears to be more gradual than would otherwise be the case. This is because when the pixels are moving between zones, there is a period of time in which the pixels are behind either or both of a horizontal rectangular cleared region 91 and a vertical rectangular cleared region 93 and the movement will not be captured in those instances. Therefore, the movement from one zone to another will require more motion on the part of the user to have the effect of movement of an object in a game (in the instance where the movement of the user is being used as an input to a computer game).

The number of horizontal rectangular cleared regions 91 and the number of vertical rectangular cleared regions 93 shown in FIG. 9 is not to be considered as limiting and is only indicative of the type of desired region mask that is proposed. Typically, the number of horizontal cleared regions will be X covering approximately between Y % and Z % of the total image area and the number of vertical cleared regions 93 will be A covering approximately between B % and C % of the total image area. Due to the fact that there is overlap between the horizontal and vertical cleared regions, the amount of the total image area covered by both the horizontal and vertical cleared areas will be of the order of between

Referring to FIG. 10 of the drawings, there is shown a diagrammatic representation of an environment in which the method according to the invention operates, indicated generally by the reference numeral 100. The environment or system comprises a plug-in, indicated generally by the reference numeral 101, referred to as “SeeWeb Xtra”, which provides the link between the web camera (webcam) 103, 105 and the game software 107. There are shown a pair of webcams, 103, 105 each for a different system, and a pair of plug-ins 101. One of the plug-ins operates with the webcam 103 and the Windows® operating system, whereas the other plug-in operates with the webcam 105 and a Mac® operating system. For ease of understanding, the plug-in has been shown as two separate plug-ins. However, practically speaking, the plug-ins will be combined into a single plug-in that can operate with either operating system.

The webcam 103 communicates with Windows DirectShow which is part of the operating system API. This captures the image from the webcam 103. This captured image is then passed to a platform independent camera layer 109 which forms part of the plug-in 101 SeeWeb Xtra for Windows. Once provided to the camera layer, the image is then processed according to the steps outlined above in an image processor 111 and the users movement is captured in a region bounded box. More specifically, the image is converted to an intensity image, the intensity image is filtered, an inter-frame difference mask is created by comparing the current image with the previous image, a desired region mask is applied if required, the pixels are grouped into bounded boxes and then the bounded boxes are grouped into region bounded boxes. The region bounded box information is passed to the SeeWeb plug-in implementation 113 which in this case has a Director Xtra stub 115 for operability with Adobe® software applications. The region bounded box information is then passed to the game software 107 which comprises one or both of a Director Authoring Application 117 with a Playback Engine 119 and a Web Browser 121 with a Shockwave Playback Engine 123.

If the region bounded box information is passed to the Director Authoring Application 117 with a Playback Engine 119, it is used for the creation and/or testing of a game and the region bounded box provides a very useful, minimum amount of data required to map the movement represented by the region bounded box to a user action in a game that they are developing. Furthermore, if the region bounded box information is passed to the Web browser 121 with Shockwave Playback Engine 123, the amount of information passed is relatively small thereby allowing very fast rendering of the inputs of the player leading to their movement being displayed almost instantaneously on a visual display unit (VDU, not shown) such as a display on a laptop or personal computer (PC).

In addition to providing the region bounded box information to the game software 107, it is possible to take earlier representations of the image taken from the platform independent camera layer 109 and the image processor 111 after the inter-frame difference mask stage, and provide these to the SeeWeb plug-in implementation 113 for onward transmission to the game software 107. These can be helpful, particularly in the game authoring application 117. Furthermore, the image taken from the independent camera layer 109 can be useful for the game playback engine 123. The plug-in can interrogate these images at both of these points and the pixel data is used to populate an image object in the Director Playback Engine in the case of the Director authoring application.

The plug-in 101 SeeWeb (Win 32) Xtra for Windows is compiled specifically for Windows XP and later versions. The plug-in 101 SeeWeb OSX Xtra for Mac is compiled specifically for Mac OSX 10.4.11 and later versions. In the embodiment described, the plug-in has been shown to operate with Adobe software “Director” however it is envisaged that other game creation software could be used in its stead. Furthermore, the game playing environment has been described as using Adobe software “Shockwave” which is suitable for games created in the Director environment however other game playing environments could be used instead, for example Flash, depending on the game creation software used. Furthermore, the cameras 103, 105 interact with Windows DirectShow and QTKIT for OS X however other suitable applications could be used in their place and these are only shown as suitable examples.

Referring to FIGS. 11(a) and 11(b), there is shown a practical use of the desired region mask. In FIG. 11(a), the player, indicated by the reference numeral 131, is moving their arms up and down alternately. If they carry out this movement the region bounded box returned will be the large rectangular box shown in FIG. 11(a). From this, it is practically impossible for the game environment to determine the direction of tilt of the player's arms. However, in FIG. 11(b), a desired region mask 133 has been placed over the image, effectively blocking out the middle third of the image. Now, a pair of region bounded boxes 135, 137 will be produced and from these it is possible to determine the tilt angle of the player's arms which can be supplied as an input to the game environment.

In the embodiments described, rectangles are used to bound the blobs and these are seen as the simplest data that the game developer can work with. If the game developer was to receive blob information he or she would then have to program a routine to draw the rectangles around the blobs. Relatively speaking, Director (shockwave) is not a particularly fast programming environment. Any image processing done on the Director side would slow the games up significantly. The plug in effectively draws tight rectangles around the blobs and feeds the information of the rectangles back to the programming environment. Furthermore, rectangles are seen as particularly useful and they are a simple way to describe an area. As an alternative, it would be possible to use ellipses to bound the regions and areas of interest but this would require more complicated mathematics to determine movement information.

For example, in one game it may be desirable to simply capture movement of a player from side to side. In such a case, the programmer simply needs to know the centre point (x coordinate) of the player's body. As the player moves left and right, rectangles are drawn around the outline of their body. A simple routine then wraps a larger rectangle around all rectangles returned by the plug in, and from that it is simple to determine the centre point. As this is all the information that the game needs to work, this is particularly computationally efficient. If the plug-in was returning blob or ellipse information, the game developer or game playing environment would still have to simplify the information down to rectangles and their centres.

In some instances, it is necessary to split the rectangle information. Perhaps the best way to explain this is with reference to FIGS. 11(a) and 11(b) and a description of an Airplane application in which there is provided a player standing in front of the camera pretending to be an airplane. The player's arms are outstretched and as they move their arms to control the left/right tilt of the plane in the game, the plug in would draw a large rectangle around all the movement (for example as shown in FIG. 11(a)). That is because almost all the body onscreen is moving, from outstretched finger tip to outstretched finger tip. In this situation it would be impossible for the programmer to determine the angle that the person was trying to portray as the programmer would be provided with one large rectangle to work with that would simply expand and contract in one or both of height and width. In order to overcome this problem, a desired region filter may be applied to the camera image. In this case, before any of the differences are looked for by the plug-in, a middle section, preferably a third of the detection area, is blocked off. This has the same effect as putting a strip of masking tape down the centre of the camera lens. When the player now moves in a plane gliding fashion the plug-in would feed the programmer with two rectangles of information, one left of the centre portion and one to the right of the centre portion. It is possible to then determine approximately the angle of the player's hands and feed that to the onscreen plane or spaceship. This is illustrated in FIG. 11(a) and (b).

In addition to the above, it was found that if a gridded area of the camera was blocked off that even more information can be gathered from the feed. The gridded area creates multiple ‘mini-screen’ units, and in each one it is possible to determine approximately the speed and direction of movement. Using the direction and speed information in combination with each other, it is possible to put those variables into in-game objects that could utilise this information.

In the embodiments described above, a Gaussian filter with a 5*5 kernel has been used however other filtering techniques for smoothing out the image could be used and indeed other dimensions of kernel could be provided if desired. The simplest technique is the box filter (sometimes called the mean filter); for a given neighborhood around and including the input pixel, the output pixel is set to the average of the sum of the neighborhood pixel values. This is fast, since it is a sum followed by a divide, but detail is softened considerably and we only want to remove noise, not actual image texture.

The technique described above, the Gaussian blur, is a particular form of center weighted mean filter: as the name implies, rather than each pixel in the input neighborhood getting an equal slice, pixels towards the center of the neighborhood have more influence on the result. This is more expensive to compute, since it involves a sum of products (pixel by weight factor) followed by a divide but gives a good balance of detail softening versus texture preservation.

More expensive techniques such as median filtering require the input neighborhood to be sorted by value for each pixel; gray level stepping is preserved by median filtering but that isn't really material for the invention described in the application in suit as there is no need to filter the edges of shapes.

With regard to kernel size; other kernel sizes could be used, a 3×3 neighborhood would be faster to compute (9 operations as opposed to 25 for a 5×5) but has a very narrow focus for noise distribution (one pixel around the pixel of interest). A Gaussian pass with a 5×5 kernel performs adequately, both in terms of computational cost and resulting image.

It will be understood that other game authoring applications and playback engines may be used. For example, shockwave 3d for the web and EXEs on the pc and the Mac (it is possible to make standalone EXEs for these platforms). Furthermore, Unity 3D, a 3D web plug-in that can make standard EXE files for Mac and pc could be used. However, Director and Shockwave are seen as particularly effective for the present invention. For example, and specifically with regard to web deployment, Adobe Flash has ubiquity and the video device functionality but does not the hardware accelerated 3d graphics rendering engine or the ability to be extended with plug-ins built for the native operating system. So performance would be an issue, as would be presentation.

Unity 3D has the hardware accelerated 3d graphics rendering engine but not the video device functionality. Neither can it be extended with native operating system functionality. It also has a relatively low installed base. Microsoft Silverlight is a further alternative with pros and cons similar to those described above in relation to Adobe Flash, though without the installed base or the video device functionality.

The web deployment case is special, since the ability to extend a web plug-in with native operating system functionality is strictly limited. The system can be integrated with any native desktop application with no such restriction (as such, any game authoring application that can produce a native desktop application—such as Unity 3D—could be used).

In addition to the above, there are alternatives to some of the method steps described above. For example, the reason that we operate on an intensity image is that we can reduce the amount of data to process to a third of the amount of data to process if we were to process in colour (in colour, the source data has a component for red, green and blue). As an alternative to the embodiment described, it would be possible to operate directly on the RGB source and threshold the difference there; it would increase the accuracy of the difference image (since the color as well as the lightness/darkness would also be taken into account) but at a computational cost.

Secondly the technique for producing the intensity image could be modified as there are numerous different ways of modeling colour. There is some justification for giving bias to the green component, since video hardware typically has more sensor area dedicated to capturing the green component due to the fact that the video hardware is trying to mimic the behavior of the human eye and the human eye discerns more green levels. In some embodiments, it may be desirable to remove the C operators from the statement and just present the actual calculation which will return the same result, namely:

Y=(0.257*R)+(0.504*G)+(0.098*B)+16

Thirdly, in certain instances, it may be possible to operate on a YUV image from the camera directly. It is envisaged that in certain circumstances the operating system and the camera hardware will provide a YUV image (the camera hardware may using that (YUV) encoding anyway as it lends itself easily to compression however the driver may just not expose it). Heretofore, the method entails polling the web camera for an RGB image which is present in all colour webcams and this RGB image is converted to an intensity image before further processing.

For connected component analysis, there are other techniques aside from the one described that could be used to equal effect. For example, it is possible to vary the connectivity or vary the method by which spans are processed. However in those cases the method operates on the same input and provides the same end result.

In this specification the terms “comprise, comprises, comprised and comprising” and the terms “include, includes, included and including” are all deemed totally interchangeable and should be afforded the widest possible interpretation.

The invention is in no way limited to the embodiment hereinbefore described but may be varied in both construction and detail within the scope of the specification.

1. A method of processing an image taken from a video device, the method comprising the steps of:
performing an inter-frame differencing technique on the image to create an inter-frame difference mask;
identifying connected regions of the inter-frame difference mask;
grouping each of the connected regions of the inter-frame difference mask in a bounded box; and
grouping the bounded boxes within a predetermined threshold distance of each other together in a region bounded box.

2. A method as claimed in claim 1 comprising the intermediate step of:
applying a desired region mask to the inter-frame difference mask.

3. A method as claimed in claim 2 in which the desired region mask comprises at least one rectangular clear region.

4. A method as claimed in claim 2 in which the desired region mask comprises a divider clear region that extends across the inter-frame difference mask thereby dividing it into two distinct areas, one either side of the clear region.

5. A method as claimed in claim 4 in which the divider clear region extends from the top of the inter-frame difference mask to the bottom of the inter-frame difference mask.

6. A method as claimed in claim 4 in which the divider clear region is located substantially centrally in the inter-frame difference mask thereby dividing the inter-frame difference mask into two substantially equal halves.

7. A method as claimed in claim 1 comprising the additional steps of:
determining whether there are a plurality of region bounded boxes in a segment of the image; and
disregarding all but the most extreme region bounded box in that segment of the image from further processing.

8. A method as claimed in claim 1 in which the step of grouping the bounded boxes within a predetermined threshold distance of each other together in a region bounded box further comprises the steps of:
expanding each bounded box by half the threshold distance;
joining each bounded box with the union of all overlapping boxes.

9. A method as claimed in claim 8 comprising the additional steps of:
sorting the bounded boxes by a union ID; and
merging bounded boxes with the same union ID into a region bounded box.

10. A method as claimed in claim 9 comprising the step of:
generating a new region bounded box for each bounded box that cannot be merged with another bounded box or region bounded box.

11. A method as claimed in claim 1 in which the step of performing an inter-frame differencing technique on the image to create an inter-frame difference mask comprises creating a binary motion mask image.

12. A method as claimed in claim 1 in which the step of performing an inter-frame differencing technique on the image to create an inter-frame difference mask comprises the steps of:
transforming the image into an intensity image comprising a plurality of pixels, each pixel having a pixel value;
filtering the intensity image to smooth out the pixel values;
subtracting each pixel value of a previous intensity image from the corresponding pixel value of the current intensity image;
calculating the absolute value of the difference between the pixel values; and
thresholding the absolute value of the difference between the pixel values.

13. A method as claimed in claim 2 in which the desired region mask comprises passing a lattice of a plurality of rectangular clear regions, a plurality of the rectangular clear regions being arranged vertically and a plurality of the rectangular clear regions being arranged horizontally and the vertical and horizontal clear regions intersecting each other to form a lattice desired region mask.

14. A computer program having program instructions for causing a computer to implement the method according to claim 1.

15. A computer program as claimed in claim 14 stored on a computer readable medium.

16. A method of providing an input to a game executing on a computing device, the method comprising the steps of:
capturing an image of the movements of a player using a video device;
performing an inter-frame differencing technique on the image to create an inter-frame difference mask;
identifying connected regions of the inter-frame difference mask;
grouping each of the connected regions of the inter-frame difference mask in a bounded box;
grouping the bounded boxes within a predetermined threshold distance of each other together in a region bounded box; and
passing the region bounded box as the input to a game playback engine.

17. A method of providing an input to a game executing on a computing device as claimed in claim 16 in which the step of capturing the movements of a player using a video device comprise capturing the movements of the player using a web camera.

18. A method of providing an input to a game executing on a computing device as claimed in claim 16 comprising the intermediate step of:
applying a desired region mask to the inter-frame difference mask.

19. A method of providing an input to a game executing on a computing device as claimed in claim 18 in which the desired region mask comprises at least one rectangular clear region.

20. A method of providing an input to a game executing on a computing device as claimed in claim 18 in which the desired region mask comprises a divider clear region that extends across the inter-frame difference mask thereby dividing it into two distinct areas, one either side of the clear region.

21. A method of providing an input to a game executing on a computing device as claimed in claim 20 or 21 in which the divider clear region extends from the top of the inter-frame difference mask to the bottom of the inter-frame difference mask.

22. A method of providing an input to a game executing on a computing device as claimed in claim 20 in which the divider clear region is located substantially centrally in the inter-frame difference mask thereby dividing the inter-frame difference mask into two substantially equal halves.

23. A method of providing an input to a game executing on a computing device as claimed in claim 16 comprising the additional steps of:
determining whether there are a plurality of region bounded boxes in a segment of the image; and
disregarding all but the most extreme region bounded box in that segment of the image from further processing.

24. A gaming system comprising:
a computing device having a processor, an accessible memory and a visual display unit (VDU);
a game engine for receiving user inputs, executing game code on the computer and displaying game graphics responsive to the user inputs on the VDU;
a video device associated with and in communication with the computing device;
a receiver to receive an image from the video device;
an inter-frame difference mask generator to generate an inter-frame difference mask from the image;
means to identify connected regions of the inter-frame difference mask;
means to group each of the connected regions of the inter-frame difference mask in a bounded box;
means to group the bounded boxes within a predetermined threshold distance of each other together in a region bounded box; and
means to deliver the region bounded box as a user input to the game engine.

25. A gaming system as claimed in claim 24 in which the video device is a web cam.

26. A gaming system as claimed in claim 24 comprising masking means to apply a desired region mask to the inter-frame difference mask.

27. A gaming system as claimed in claim 26 in which the desired regions mask comprises at least one rectangular clear region.

28. A gaming system as claimed in claim 27 in which the desired region mask comprises a divider clear region that extends across the inter-frame difference mask thereby dividing it into two distinct areas, one either side of the clear region.

29. A gaming system as claimed in claim 28 in which the divider clear region extends from the top of the inter-frame difference mask to the bottom of the inter-frame difference mask.

30. A gaming system as claimed in claim 28 in which the divider clear region is located substantially centrally in the inter-frame difference mask thereby dividing the inter-frame difference mask into two substantially equal halves.

31. A gaming system as claimed in claim 24 comprising:
means to determine whether there are a plurality of region bounded boxes in a segment of the image; and
means to disregarding all but the most extreme region bounded box in that segment of the image from further processing.

32. A method of developing a game for a gaming system as claimed in claim 24 comprising the steps of:
capturing an image of the desired movements of a player using a video device;
performing an inter-frame differencing technique on the image to create an inter-frame difference mask;
identifying connected regions of the inter-frame difference mask;
grouping each of the connected regions of the inter-frame difference mask in a bounded box;
grouping the bounded boxes within a predetermined threshold distance of each other together in a region bounded box;
designating the region bounded box as a user input to a game; and
matching the user input with a game action.
